(19) United States
(12) Patent Application Publication
(10) Pub. No.: US 2017/0322082 A1
(43) Pub. Date: Nov. 9, 2017

(54) attachable spectroscope to an auxiliary CCD or CMOS camera as detector for gem identification

(71) Applicant: Meijun Li, Beijing (CN)

(72) Inventor: Meijun Li, Beijing (CN)

(21) Appl. No.: 15/660,213

(22) Filed: Jul. 26, 2017

Related U.S. Application Data
(63) Continuation of application No. 15/435,302, filed on Feb. 21, 2017, now abandoned.

(30) Foreign Application Priority Data
Mar. 9, 2016 (CN) 2016201802610

(51) Int. Cl. G01J 3/28; G01N 21/87; G01J 3/18; G01J 3/02; G01J 3/14; H04N 5/225; G01N 21/25

(52) U.S. Cl. CPC G01J 3/2823; H04N 5/2254; G01N 21/87; G01N 21/255; G01J 3/0202; G01J 3/14; G01J 3/0256; G01J 3/18

(57) ABSTRACT

The present invention includes a spectroscope for gem identification and a fixing device to connect the spectroscope and an auxiliary image sensor. The functional compartments of the spectroscope concerning the present invention include a tube, an incident window, a slit, lens, a newly designed grism, and an exit window; there are two different kind of fixing device designed to fulfill its purpose, one is a clamp, the other is a shell.

### BACKGROUND OF THE INVENTION

### 1. Technical Field

The present invention relates to gem identification, specifically using a newly designed spectroscope with CCD (Charge-couple Device) or CMOS (Complementary Metal Oxide Semiconductor) or naked eye as detector for gem identification.

### 2. Description of the Related Art

In the field of gem identification, to get concrete information of gem species with traditional handhold spectroscope, one has to be well trained with professional skills to read the spectrum with naked eyes. In this process, the identification of the gem is very likely to be compromised because of personal error. Further more, an extend period of time observation can lead to certain ophthalmic diseases such as visual loss and macular degeneration. Moreover, the spectrum obtained by the traditional handhold spectroscope cannot be captured, stored or shared for peer communication or further study.

### SUMMARY OF THE INVENTION

The present invention has been made in the view of the above-mentioned circumstance, it is a device capable of not only directly observation the spectrum of certain gem species but also capturing and storing the spectrum by a mobile phone or any devices with a applicable CCD or COMS camera with higher resolution. Thus, the present invention enables users to have transitive, preservable and repeatable spectrum data that can be further analyzed by software.

To achieve abovementioned utility, the functional compartments of the spectroscope concerning the present invention include a tube, an incident window, a slit, lens, a newly designed grism, an exit window and a fixing device to connect the camera and the spectroscope, each compartment is described as follows:

The incident window is located on one side of the tube with the slit near it. The exit window is on the other side of the tube; the diffracting grism locates close to the exit window in the tube.

The fixing device is designed to be a clamp or shell which incorporates screw to fix the spectroscope on the exit window side, and an avoid hole in the inside the screw. The avoid hole is transparent and aligned to the camera, thus, the light ray of the gem under test goes through the incident window, the slit, the lens, the newly designed grism and the exit window, then the light beam goes into the camera and collected by the CCD or CMOS image sensor, the light spectrum can be transferred into digital data.

Further features of the present invention includes a slit base to fix the abovementioned slit, a lens base to fix the abovementioned lens, a prism base to fix the abovementioned grism. Moreover, the grating constant of the grism is 1200, which are different from the grism in traditional handhold spectroscope.

The present invention is different from traditional spectroscope in two major aspects. Firstly, the theoretical spectrum resolution of the present invention is 0.38 nm, i.e. this new spectroscope can separate light with wavelength difference as small as 0.38 nm apart by grating diffraction, in comparison, the resolution of traditional spectroscope is 1.5 nm. The four-time improvement in resolution is because of the two times elevated grism constant. Thus, the spectrum obtained from the present invention with fine structure can provide more information on the identity of the gem under test.

Secondly, the spectrum obtained from the present invention can be read with both naked eyes just like traditional handhold spectroscope, but with four-times higher sensitivity, and with CCD or COMS image sensor of the camera on, for example, smart phone or digital camera. The whole device integrates a higher resolution spectroscope to diffract light, a fixing device to attach the spectroscope and the camera together, and an auxiliary device with CCD or CMOS as photo sensor. Therefor, a person with little or no professional skills can easily grasp its application method of the spectroscope, which is to place the gem under test on the incident window, click the “capture” button of, say a smartphone, the spectrum of the gem will be shown on the screen, this image can be saved and further shared or analyzed. Moreover, the present invention overcomes not only the potential human error but also visual impairment to the user of traditional handhold spectroscope.

### BRIEF DESCRIPTION OF THE DRAWINGS

Further features of the present invention will become apparent from the following description exemplary embodiments with reference to the attached drawings.

FIG. 1 is a cross-section diagram illustrates the spectroscope of the present invention.

FIG. 2 is a cross-section diagram illustrates the newly designed grism, the diffracting grating on the slope surface is shown by the side

FIG. 3 is a perspective view of clamp as the fixing device.

FIG. 4 is a perspective view of shell as the fixing device.

### DESCRIPTION OF THE EMBODIMENTS

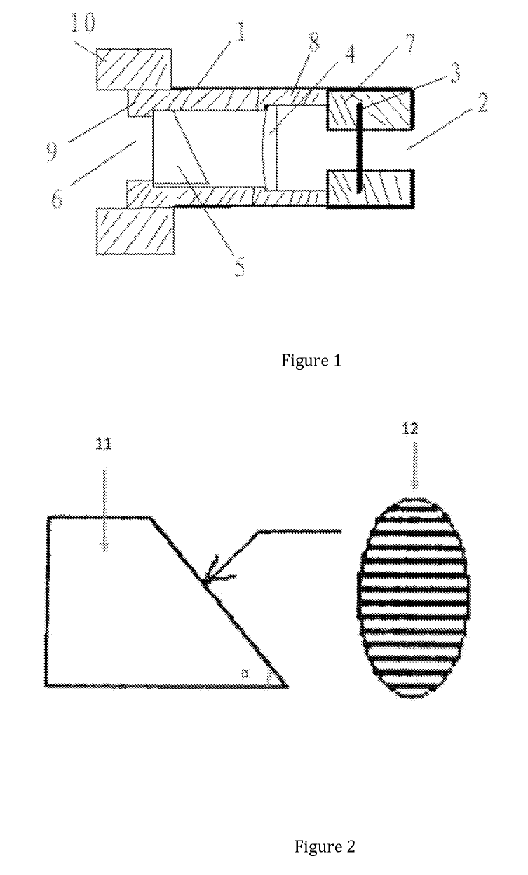

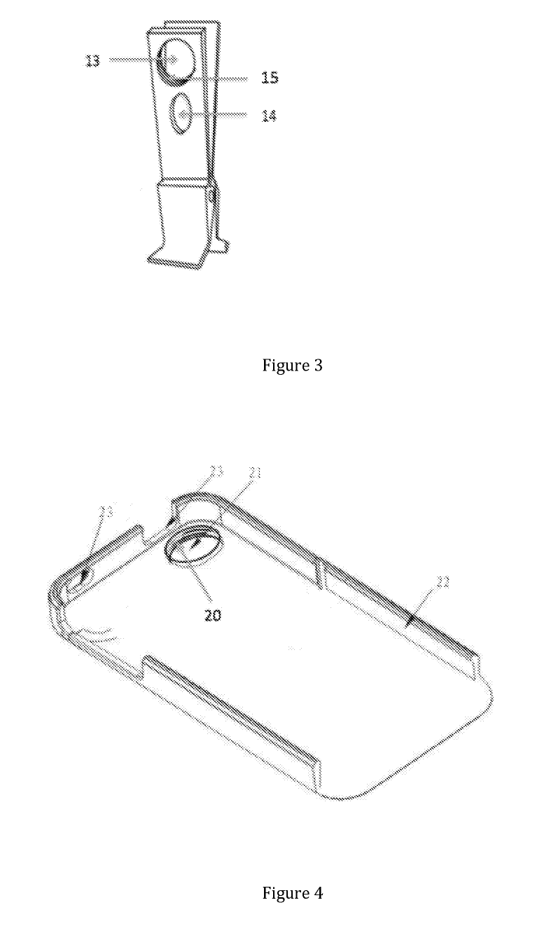

Now, an embodiment of the present invention is described in detail with reference to the attached drawings. FIG. 1 is a cross-section diagram illustrates the spectroscope of the present invention, FIG. 2 is a cross-section diagram illustrates the newly designed grism, the diffracting prism on the angular surface is shown by the side, FIG. 3 is a perspective view of clamp as the fixing device, FIG. 4 is a perspective view of shell as the fixing device.

The basic structure of the spectroscope is described with reference to FIG. 1 including a tube 1, an incident window 2, a slit 3, lens 4, a newly designed grism 5, an exit window 6 and a fixing spiral groove 10 to attach the spectroscope with fixing device.

The incident window 2 is located on one side of the tube 1 with the slit 3 placed near the incident window 2 inside the tube 1. The exit window 6 is on the other side of the tube, the diffracting grism 5 locates close to the exit window 6 in the tube 1.

With reference to FIG. 3, a basic structure of the clamp as the fixing device according to the embodiment of the present invention is described. The clamp incorporates screw 15 to fix the spectroscope on the exit window side, and an avoid hole 13 in the inside the screw 15.

Next, a basic structure of the shell as the fixing device according to the embodiment of the present invention is described. The shell incorporates screw 20 to fix the spectroscope on the exit window side, and an avoid hole 21 in the inside the screw 20.

The spectroscope is fixed on the camera of an auxiliary device with CCD or CMOS as photo sensor by the clamp or shell as fixing device, thus, the light ray of the gem under test goes through the incident window, the slit, the lens, the newly designed grism and the exit window, then the light beam goes into the camera and collected by the CCD or CMOS image sensor, the light spectrum can be transferred into digital data.

Next, other basic structure of the attachable spectroscope is described with reference to FIG. 1 including the slit base 7 to fix the slit 3.

Next, other basic structure of the attachable spectroscope is described with reference to FIG. 1 including the lens base 8 to fix the slit 4.

Next, other basic structure of the attachable spectroscope is described with reference to FIG. 3 including avoid hole 14 to make room for the functional key on the axillary camera device.

Next, other basic structure of the attachable spectroscope is described with reference to FIG. 4 including avoid hole 23 to make room for the functional key on the axillary camera device.

Next, other basic structure of the attachable spectroscope is described with reference to FIG. 4 including belt 22 to fix the axillary camera device such as a smart phone.

With reference to FIG. 2, a basic structure of the grism as the diffraction element according to the embodiment of the present invention is described. The cross-section prism 10 is triangle rectangle, the grating is set on the slope surface of the prism. The basic angle α of the prism 11 is calculated based on the refractivity of the glass and prism constant. For example, the material name of the glass is H-ZF88 under the nomenclature of CDGM Glass Co., Ltd, the code of the glass is 946179 its refractivity is relatively high, and the grating constant of the prism is 1200, accordingly, the calculated basic angle α of the prism is different compared to the grism in traditional handhold spectroscope whose grating constant is 600. Both the resolution and the angular dispersion power improved by four-time. Under the set of the present invention, the spectrum one can collect from the exit window covers the visible light, from 400 nm to 800 nm, the center of the spectrum 550 nm, which is the wavelength of green light. The fine features of a gemstone under test, such as the absorption lines and emission lines are clearer to the observer owing to the improved resolution and extended spectrum, moreover, the spectrum can be captured easily to further analysis.

The present invention is different from traditional spectroscope in two major aspects. Firstly, the theoretical spectrum resolution of the present invention is 0.38 nm, i.e. this new spectroscope can separate light with wavelength difference as small as 0.38 nm apart by grating diffraction, in comparison, the resolution of traditional spectroscope is 1.5 nm. The four-time improvement in resolution is because of the two times elevated grating constant.

Thus, the spectrum obtained from the present invention with fine structure can provide more information on the identity of the gem under test.

Secondly, the spectrum obtained from the present invention can be read with both naked eyes just like traditional handhold spectroscope, but with four-times higher sensitivity, and with CCD or COMS image sensor of the camera on, for example, smart phone or digital camera. The whole device integrates a higher resolution spectroscope to diffract light, a fixing device to attach the spectroscope and the camera together, and an auxiliary device with CCD or CMOS as photo sensor. Therefor, a person with little or no professional skills can easily grasp its application method of the spectroscope, which is to place the gem under test on the incident window, click the “capture” button of, say a smartphone, the spectrum of the gem will be shown on the screen, this image can be saved and further shared or analyzed. Moreover, the present invention overcomes not only the potential human error but also visual impairment to the user of traditional handhold spectroscope.

It is to be clear that at industrial application, the modules of present invention, that is, the newly designed spectroscope and the fixing device can combine as a whole, or function independently.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

The invention claimed is:

1. An attachable spectroscope to an auxiliary CCD or CMOS camera as detector for gem identification, wherein the spectroscope comprising: a tube, an incident window, a slit, lens, a newly designed grism, and an exit window; the fixing device is designed to be a clamp or shell which incorporates screw to fix the spectroscope on the exit window side, and an avoid hole in the inside the screw. The incident window is located on one side of the tube with the slit near it. The exit window is on the other side of the tube; the diffracting grism locates close to the exit window in the tube.
The fixing device is designed to attach the spectroscope to the auxiliary camera as detector, it incorporates a screw to fix the spectroscope on the exit window side, and an avoid hole in the inside the screw. The avoid hole is transparent and aligned to the camera, thus, the light ray of the gem under test goes through the incident window, the slit, the lens, the newly designed grism and the exit window, then the light beam goes into the camera and collected by the CCD or CMOS image sensor, the light spectrum can be transferred into digital data.

2. The attachable spectroscope according to claim 1, wherein a slit base to fix the abovementioned slit.

3. The attachable spectroscope according to claim 1, wherein a lens base to fix the abovementioned lens.

4. The attachable spectroscope according to claim 1, wherein a prism base to fix the abovementioned grism.

5. The attachable fixing device according to claim 1, wherein its width equals or smaller than that of the auxiliary phone camera. The fixing device can seize the auxiliary phone camera by a stretchable belt structure.

6. The attachable fixing device according to claim 1, wherein avoid holes aligned to the functional parts of the auxiliary camera such as operational keys.

7. The attachable spectroscope according to claim 1, wherein a grating constant of the grism is 1200, the material name of the glass to make the prism is H-ZF88 under the nomenclature of MGM Glass Co., Ltd, the code of the glass is 946179.
